(19) United States
(12) Patent Application Publication
(10) Pub. No.: US 2006/0267255 A1
(43) Pub. Date: Nov. 30, 2006

(54) Process for producing a performance enhanced single-layer blow-moulded container

(76) Inventors: Daniela Tomova, Laegerdorf (DE); Stefan Reinemann, Rudolstadt (DE); Alec Milligon, Cavan (IE); Maura Burke, Cavan (IE)

Correspondence Address: BIRCH STEWART KOLASCH & BIRCH, PO BOX 747, FALLS CHURCH, VA, 22040-0747, US

(21) Appl. No.: 10/543,652

(22) PCT Filed: Jan. 23, 2004
(86) PCT No.: PCT/IE04/00011

§ 371 Date: Jun. 15, 2006

(30) Foreign Application Priority Data
Jan. 31, 2003 (IE) S20030057

(51) Int. Cl. B29C 49/00

(52) U.S. Cl. 264/540

(57) ABSTRACT

A process for producing a single-layer blow-moulded container having improved mechanical, thermo-mechanical and barrier properties without loss of impact strength or stress-crack resistance is disclosed. The container is produced by direct extrusion of masterbatch with polyethylene matrix resin. The viscosity of the masterbatch (η_{MB}) and the viscosity of the polyethylene matrix resin (η_{PE}) are in the ratio of between 0.3 to 1.9 at a shear rate of between 10 to 100 1/s. The invention also relates to the single layer blow moulded container produced by that process.

### INTRODUCTION

The present invention relates to a process for producing a singe-layer blow-moulded container having improved mechanical, thermo-mechanical and barrier properties, without loss of impact strength, or stress-crack resistance. The invention further relates to a single-layer blow-moulded container prepared by that process.

It is well known to manufacture blow moulded containers from polymers, these containers have found applications in the storage of aggressive chemicals and as fuel tanks. It is further well known that the addition of inorganic days to polymers for the manufacture of these containers and other polymer articles extends the characteristic profile of the polymer and brings new application potentials for the polymer. The loading of small amounts of clay into a polymer matrix results in an increase in the mechanical strength, tensile modulus and dimensional stability at heat of the resultant polymer article. The use of nanoclay particles, e.g. synthetic or natural layer silicate clays which exhibit a large aspect ratio is particularly attractive. The aspect ratio is defined as the ratio of a particular object's width to its thickness. In order to enrich enhanced properties of the polymer/layered silicate nanocomposites a good intercalation of the polymer into the layered silicate and in particular exfoliation of the polymer in the layered silicate is required. Exfoliation occurs in nanocomposites, where the silicates are uniformly dispersed in single layers or the layered silicates are delaminated.

Before further discussion a definition of the following terms will aid in the understanding of the present invention.

Barrier—a property which indicates that the penetration or permeation of gases or liquids beyond a material having that property is prevented.

Compatibiliser—a compound which can modify the surface of a nanoclay so that it is attracted to and will disperse in resin matrices.

Container—articles for the storage and transport of goods.

Extruding—forcing a semi soft solid material through the orifice of a die to produce a continuously formed piece in the shape of the desired product.

Masterbatch—an additive containing a high loading of nanoclay.

Melt Index—the rate of flow (extrusion) of molten resin through a standard die, under specified conditions of temperature and load.

Modified nanoclay—a layered nanoclay material which has undergone chemical modification on the surface i.e. where organic molecules have been positioned between the layered platelets to increase the interlayer spacing between the platelets.

Nanoclay—clays having one dimension in the nanometer range.

Nanocomposite—a polymer having dispersed therein layered platelets of a modified clay.

Nanocomposite resin—a polymer comprising an amount of nanocomposite.

Blow moulding applications require increased mechanical and thermo-mechanical properties in various demanding transport and storage applications in addition to increased barrier properties towards many chemicals including hydrocarbons and acids. Polyethylene is the polymer of choice in many applications including blow moulding and pipe manufacturing due to its excellent resistance to most chemicals and high impact strength. Polyethylene, however, has been found to have a poor barrier towards hydrocarbons which limits the application for storage of solvents based on hydrocarbons as well as fuels.

There is therefore a need for blow-moulded containers manufactured from polyethylene having improved mechanical, thermo-mechanical and barrier properties, without compromising the impact properties.

Previous attempts have been made at overcoming these limitations by manufacturing containers having more than one layer, whereby at least one layer is impermeable to hydrocarbons. International Publication Nos. WO 01/87580 and WO 01/87596 disclose multilayer containers for flowable products having improved barrier and/or mechanical properties. The polymers used include polyethylene as well as other types of polyolefins, polyesters and depends on a multi-layer structure. Containers having multi-layer walls are produced using co-extrusion blow-moulding which is an expensive and complex process. Further disadvantages of this method of blow moulding include compromised mechanical properties as well as poor recycleability. Additionally as the container comprises more than one layer, more polymer is required per container resulting in increased costs and heavier containers.

International Publication No. WO 02/079318 discloses a nanocomposite material with good barrier properties which comprises a polymer matrix consisting of polyolefin, maleic anhydride grafted polyolefin, polyamide, and a proprietary treated nanoclay. The essential addition of polyamide in the process is disadvantageous in that polyamide is an additional polymer component and its use results in poor recycleability of the resultant product. Additionally the polyamide based masterbatch must be pre-dried for 5 hours at 80-90° C. before processing. The process disclosed, further requires the virgin nanoclay to be treated with epoxydized Bis-phenol A in chloroform as solvent or epoxy silane in methanol as solvent. This type of modification is not of economic interest because of the nature of the solvents used. The presence of Bis-Phenol A and/or Epoxies can also cause difficulties in the recycling of the material due to the strong interactions and possible formation of cross-links. Furthermore, the requirement of nanoclay pretreatment is time-consuming.

The application of nanoclay technology to high barrier blow moulded high density polyethylene (HDPE) containers for storage of hydrocarbon solvents and fuels is disclosed in “High Barrier Blow Moulded Containers based on Nanoclay Composites” Kenig et al. As in the case of PCT Publication No. WO 02.079318 the barrier improvement depends on the use of proprietary treated nanoclays and the presence of polyamide which is more impermeable towards hydrocarbons than HDPE.

PCT Publication No. WO 01/05879 discloses a process for the production of a polyolefin-based composite material comprising a polyolefin, a layered clay and a peroxide. U.S. Pat. No. 4,317,765 discloses a compatibilised filled polyolefin composition comprising a polyolefin and a free radical catalyst such as peroxide. In each of the above compositions the peroxide is used as a catalyst to enhance the reaction between the polymer and the maleic anhydride and/or the interaction between the polymer and the clay. The disadvantage of using peroxide however is the increased cost. Furthermore the use of peroxide allows the cross-inking of the polymer such that the resultant nanocomposite would be unsuitable for the production of blow moulded containers.

There is therefore a need for a single-layer blow-moulded container with improved mechanical, thermo-mechanical and barrier properties, without compromising the impact properties or stress crack resistance such that it can transport and store aggressive chemicals such as acids and hydrocarbon containing solvents e.g. paint thinners, petrol, toluene and xylene. There is also a need for a simple process for producing these containers which can use commercially available clays and is therefore cheaper and more environmentally friendly and attractive to large scale industrial processing.

### STATEMENTS OF INVENTION

The present invention relates to a process for producing a single-layer blow-moulded container comprising:
providing a masterbatch consisting of maleated polyethylene and a modified nanoclay in the amount of 20% to 50% by weight of the masterbatch;
directly extruding the masterbatch in the amount of 5% to 20% by weight with a polyethylene matrix resin at a viscosity ratio of between 0.3 to 1.9 at a shear rate of between 10 to 100 1/s; and
at a temperature of between 150° C. and 230° C. to form the single-layer blow-moulded container.

The principal advantage of producing single layer containers is that they are cheaper to produce, predominantly because less polymer is required to manufacture each container. Furthermore the production of single layer containers is less complex and expensive than the production of multilayer containers in that it does not require the use of co-extrusion blow moulding which is a complicated and expensive process and is an essential processing step in the production of multilayer containers.

Furthermore this process for producing a single layer container is more economic in that it does not require pretreatment of any of the components which are all commercially available and therefore requires less processing steps.

A further advantage of single-layer containers is that they are easier to recycle than multilayer containers. As multi-layer containers comprise a number of different types of layers where each layer is made from a different polymer, i.e. some layers are permeable to hydrocarbons whereas others are impermeable, they are not conducive to recycling. The blow-moulded containers disclosed in this invention are completely recyclable and reusable in their original application. Due to the increased emphasis being placed on end-of-life requirements at present in industry, this is an important advantage.

Yet another advantage of the single-layer containers of this invention is that even though they are lighter and thinner than conventional multi-layer containers and are therefore more easily transported and stored, the impact strength and stress crack resistance of the containers are not compromised.

Preferably the viscosity of the masterbatch (η_{MB}) and the viscosity of the polyethylene matrix resin (η_{PE}) are in the ratio of between 0.7 to 1.3 at a shear rate of between 10 to 100 1/s.

The advantage of the viscosity ratio η_{MB}/η_{PE} being in the region of 0.3 to 1.9 and more preferably between 0.7 to 1.3 at a shear rate of between 10 to 100 1/s is that a more homogenous mixture is formed between the two components during extrusion resulting in containers having increased barrier and mechanical properties. The viscosity ratio should be as close to 1 as possible in order to achieve a homogenous mixture which is readily miscible with well dispersed and exfoliated silicate platelets. It has been found that the clay content as well as the intercalation/exfoliation degree strongly influence the rheological behaviour of the masterbatch. Thus the viscosity can be optimised by varying the day content in the masterbatch. A higher day loading results in a higher viscosity. The more exfoliated platelets are dispersed in the polyethylene the lower the viscosity. A day concentration of 20% to 50% by weight of the masterbatch has been found to be optimal to provide this viscosity ratio. Preferably the clay content should be in the region of 26% by weight of the masterbatch. At this clay concentration the masterbatch has been found to have the most similar flow behaviour to the polyethylene matrix resin, and is readily miscible with the polyethylene matrix resin.

Typically the concentration of the nanoclay in the nanocomposite would be in the region of 1.6% to 8% by weight of the nanocomposite. Therefore the masterbatch comprises a higher concentration of nanoclay than would be expected in a nanocomposite, which would result in a large increase in the viscosity of the masterbatch. It has been found that in order to decrease the viscosity of either the masterbatch or the polyethylene matrix resin the temperature and/or shear rate should be increased. The advantage of extruding at a temperature of between 150° C. and 230° C. is that this temperature range provides optimal conditions for direct extrusion of masterbatch. Masterbatch having a clay content in the region of 20% by weight and polyethylene matrix resin have been found to have a similar viscosity at temperatures less than 200° C. However, generally a higher content of clay requires a higher processing temperature during extrusion. If the day content in the masterbatch is greater than 26% by weight of the masterbatch the extrusion temperature may rise to 210° C. The extrusion temperature should be increased to between 220° C. and 230° C. when the clay content in the masterbatch is in the region of 40% by weight of the masterbatch.

The processing temperatures also have an effect on the melt index on some of the components. For example the melt index of the nanocomposite is adversely affected by temperature, whereas the melt index of polyethylene matrix resin remains constant with an increase in temperature. The melt index of the nanocomposite is more stable for a longer time at temperatures between 190° C. and 200° C. The melt index of the nanocomposite at 215° C. increases within 20 minutes from 7 to 10 ccm/10 min. It is therefore generally favourable to add processing stabilizer at temperatures above 220° C.

The advantage of directly extruding the masterbatch is that it obviates the need for a processing step thereby resulting in a more economical process. The direct extrusion of the masterbatch allows for stronger containers to be formed due to the higher content of clay in the container.

In one embodiment of the invention the maleated polyethylene is prepared by adding maleic anhydride to polyethylene in the amount of less than 2% by weight of the polyethylene.

The advantage of using maleated polyethylene is that it acts as a compatibilser. Some polyolefins such as polyethylene are non polar and therefore have been found to be incompatible with polar clays, resulting in inhomogeneties like silicate clusters in the nanocomposites. The use of the compatibiliser can increase the interaction between the nanoclay and the polymer and also allows chain growth during polymerisation.

In a further embodiment of the invention the nanoclay is modified by cation exchange with an alkyl ammonium ion.

The advantage of modifying the nanoclay by cation exchange with an alkyl ammonium ion is that this provides increased gaps between the silicate layers of the nanoclay and allows the interpenetration of polymer chains into these gaps.

Preferably the nanoclay is a natural or synthetic silicate clay.

Ideally the nanoclay is a smectite clay selected from the group consisting of one or more of montmorillonite, saponite, beidellite, nontronite and hectorite or any analogue thereof.

The advantage of using a nanoclay is that there is a large surface area for interaction with the polymer. The advantage of using a smectite day is that it is a swellable clay and therefore the clay platelets can swell which allows it to more readily disperse in polymer resins.

Preferably the concentration of nanoclay in the blow-moulded container is in the range 1% to 10% by weight of the container.

Ideally the polyethylene matrix resin is selected from the group consisting of one or more of polyethylene (PE), high density polyethylene (HDPE) and high molecular weight high density polyethylene (HMW HDPE). The advantage of using polyethylene as the matrix resin is that polyethylene has been found to have high impact strength and has excellent resistance to most chemicals.

Further preferably the polyethylene matrix resin is HMW HDPE with a melt index in the range of between 2 g/10 min and 25 g/10 min at 21.6 kg and 190° C. The advantage of using HMW HDPE with a melt index in the range of between 2 g/10 min and 25 g/10 min at 21.6 kg and 190° C. is that the resulting containers have high impact strength and increased stress crack resistance.

The present invention further relates to a process for producing a single-layer blows moulded container wherein subsequent to providing the masterbatch carrying out the additional steps of:
forming a nanocomposite resin by compounding the masterbatch in the amount of 8% to 16% by weight of the nanocomposite resin with polyethylene matrix resin;
extruding the nanocomposite resin at a temperature of between 150° C. and 230° C. to form the single layer blow-moulded container.

### DETAILED DESCRIPTION OF THE INVENTION

The invention will be more clearly understood from the following description thereof with reference to the accompanying drawings wherein:

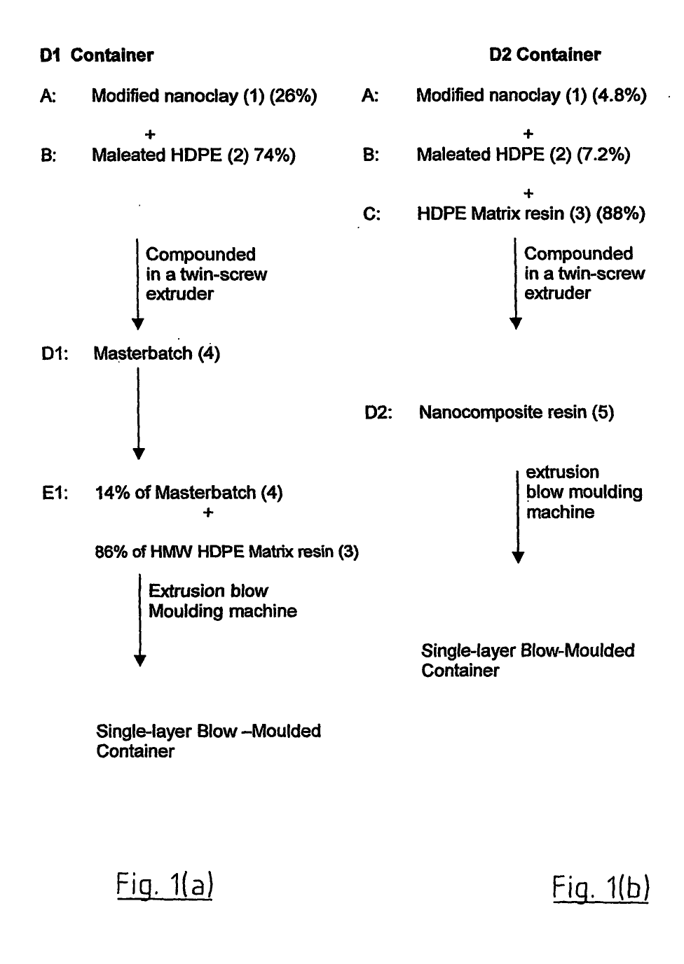

FIG. 1 is a process outline of production of single-layer blow-moulded containers
(a) D1 container from masterbatch added to HDPE in extrusion blow moulding process.
(b) D2 container from nanocomposite resin

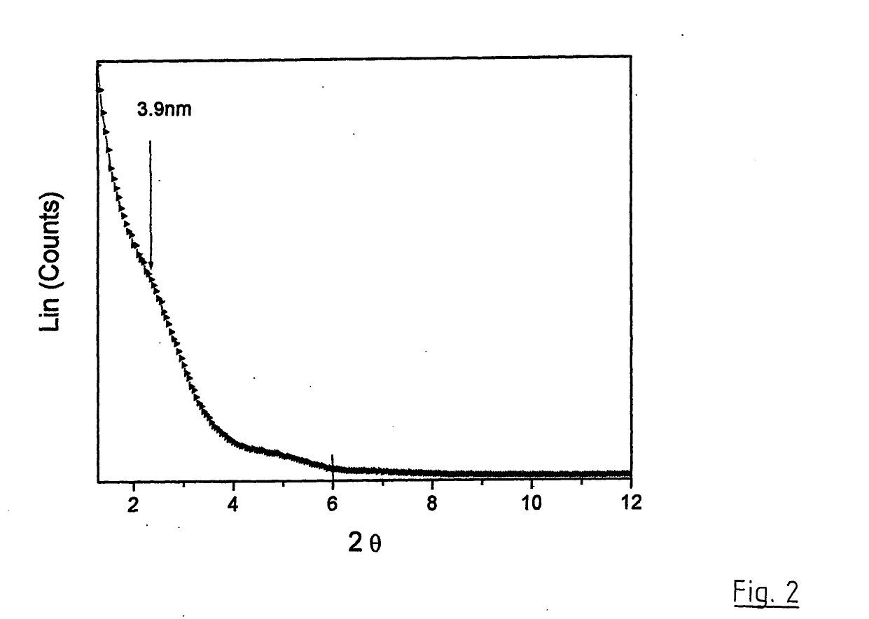

FIG. 2 X-Ray-diagram of masterbatch with 26% nanoclay by weight of the masterbatch illustrates the intercalation of the maleated HDPE between the layers of the nanoclay.

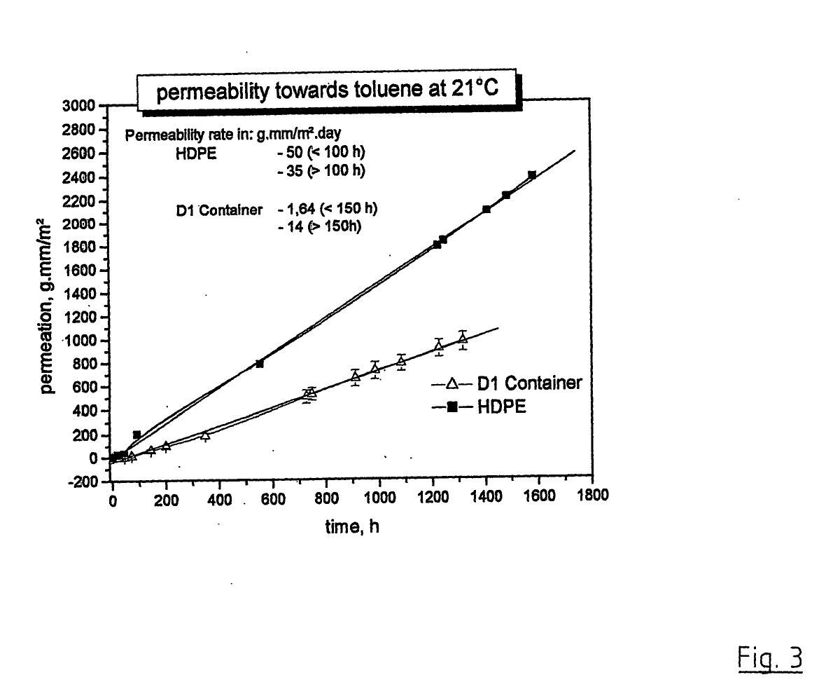

FIG. 3 illustrates the permeability of the blow-moulded containers (from D1) towards toluene at over time at 21° C.

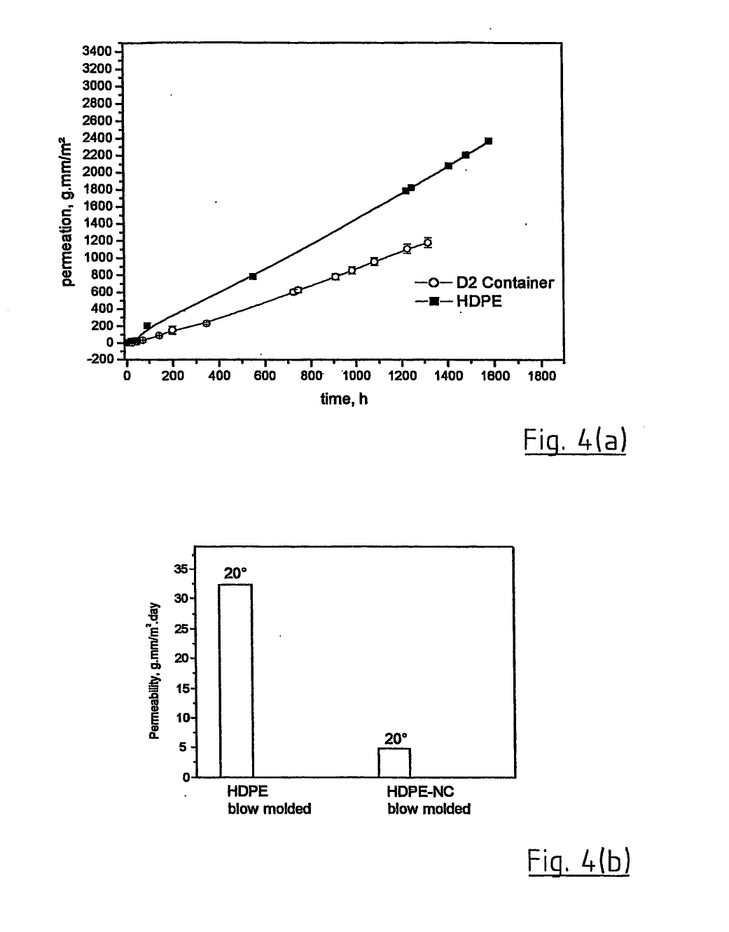

FIG. 4 illustrates the permeability of the blow-moulded containers (from D2) towards toluene at
(a) 21° C.
(b) 20° C.

According to FIG. 1, there is provided a process for the production of a single-layer blow-moulded container comprising:
A. Nanoclay, which has been organically modified by cation exchange with an alkyl ammonium ion, to yield modified nanoclay (1) is obtained commercially.
B. Commercially available maleated High Density Polyethylene (HDPE) (2), grafted with 1% Maleic anhydride by weight of HDPE is obtained as compatibiliser.
C. High Molecular Weight, High Density Polyethylene (HMW HDPE) (3) with a melt index of 2-3 g/10 min at 21.6 kg load and 190° C. is obtained.
D1 26% by weight of modified nanoclay (1) and 74% by weight of maleated HDPE (2) is compounded in a twin screw extruder to produce a masterbatch (4) with a nanoclay concentration of 26% by weight of the masterbatch (4).
D2 4.8% by weight of modified nanoclay (1) is combined with 7.2% of maleated HDPE (2) and compounded (in a twin screw extruder) with 88% of HDPE matrix resin (3) to yield a nanocomposite resin (5).
E. The masterbatch (4) from D1 is added at 14% by weight to the HDPE matrix resin (3) in the extrusion blow-moulding machine at processing temperatures between 150° C. and 230° C. preferably from 150° C. to 190° C. to yield blow-moulded containers with enhanced mechanical, thermo-mechanical and barrier properties.
F. The masterbatch (4) from D1 is added at 13% by weight to the matrix HDPE resin (3) with 2% commercially available colour masterbatch.
G The nanocomposite resin (5) from D2 was fed into the extrusion blow moulding machine and processed at temperatures between 150° C. and 230° C. preferably from 150° C. to 190° C. to yield blow-moulded containers with enhanced mechanical, thermo-mechanical and barrier properties.

### EXAMPLE 1

### Mechanical Properties (D1 Masterbatch and Injection Moulded Testpieces)

Standard Rigidex HM5420XP HDPE was supplied by BP Solvay

Melt Flow index=2 g/10 min (190° C./21.6 kg)

Treated nanoclay was sourced from Nanocor Inc. (organically modified by cation exchange with an alkyl ammonium ion.)

Commercially available maleated HDPE was sourced from DuPont.

Nanoclay (1) maleated HDPE (2) were compounded in a twin screw extruder to produce a masterbatch (4) having a melt index of 2.6 ccm/10 min at 21.6 kg load with a nanoclay concentration of 26% and a maleated HDPE concentration of 74% by weight of the masterbatch. The masterbatch was found to have a viscosity of 1610 Pa·s at a shear rate of 100 1/s.

As illustrated in FIG. 2 there was a strong interaction between the maleated HDPE and the nanoclay. The initial interlayer distance of the nanoclay used was 2.6 nm. By means of X-ray diffraction it was determined that the nanoclay was intercalated.

Injection Moulded D1 Testpieces

13.5% by weight of masterbatch (4) having a melt index of 2.6 ccm/10 min at 21.6 kg load was added via injection moulding to 86.5% by weight HDPE matrix resin. The HDPE matrix resin was found to have a viscosity of 2050 pa·s at a shear rate of 100 1/s. (3), BP Solvay Rigidex HM5420XP, having a melt index of 2 g/10 min at 21.6 kg load to give test specimens for mechanical testing. The final concentration of the day was 3.5% by weight of the HDPE. The properties of the test pieces are illustrated in Table 1

TABLE 1
Mechanical Properties of Nanocomposite testpieces

| | Tensile | Tensile | Elongation | Young- |
|---|---|---|---|---|
| Sample | stress | strain | at break | Modulus [MPa] |
| [wt-% clay] | [MPa] | [%] | [%] | (improvement) |
| Standard | | | | |
| (BP Rigidex | 37 | 8.8 | 9.8 | 1280 |
| 5420XP) | | | | |
| Testpieces D1 | 40 | 7.6 | 11 | 1812 (+41%) |

Table 1 shows increased mechanical properties of the D1 testpieces as compared to the standard Rigidex. There was noted an especially high increase in the Young Modulus which measures the ratio of the stress applied to the material compared to the resulting strain. Therefore a much higher stress needs to be applied to the containers of the present invention as compared to the standard Rigidex containers In order for the container to be affected.

### EXAMPLE 2

### D1 Container

Rigidex HM5030XP HDPE was supplied by BP Solvay

Melt Flow index=3 g/10 min (190° C./21.6 kg)

Treated nanoclay was sourced from Nanocor Inc. (organically modified by cation exchange with an alkyl ammonium ion).

Commercially available maleated HDPE was sourced from DuPont.

Masterbatch (4) was prepared in a twin screw extruder as in Example 1. 14% of masterbatch was added to 86% of Rigidex HM5030XP HDPE matrix resin. The processing conditions are defined as follows:

Extruder Temperatures: 170, 180, 180, 185, 190° C.

Melt temperature: 190° C.

Coloured Container

A blow-moulded container was produced using the masterbatch (4) (13% by weight), having a melt index of 2 ccm/10 min at 21.6 kg load (190° C.), masterbatch colour Blue 5010 (2% by weight), and HDPE (85% by weight) (having a melt index of 3 g/10 min 21.6 kg load (190° C.)) which are mixed in the blow-moulding machine. The viscosity ratio was η_{MB}/η_{PE}=0.78 at a temperature of 190° C. and a shear rate of 100 1/s. The processing conditions in extrusion blow-moulding are defined as follows:

Extruder Temperatures: 170, 180, 180, 185, 190° C.

Melt temperature: 190° C.

The masterbatch colour Blue 5010, is a widely used colour component, which would have no effect on the properties of the container.

Permeability Test

According to FIG. 3, there is illustrated the results of a permeability test, which was carried out on sheets from a single-layer blow-moulded container. The sheets were cut into circular sheets having a diameter of 8 mm and were used as a seal between a small bottle and a pinhole lid. The diameter of the pinhole was 5.35 mm. The bottles were stored at a constant temperature of 21° C. (5 bottles from each sample and for the respective temperature). The weight loss of the toluene in the bottles was measured periodically and the results are given as a weight loss versus time plot. The permeability rate per day was calculated using the linear regression curve up to 100 h at first, and then along the entire measured time.

The results indicate that the single-layer blow-moulded containers of the present invention are substantially less permeable than standard HDPE containers.

Tensile Test

Samples in the form of test bars are stamped from the single-layer blow-moulded container. The tensile properties Young-modulus, tensile strength, yield strain, and elongation at break of the samples are determined according to DIN EN ISO 527. The results are given in Table 2.

Impact Test

Puncture impact test according to DIN EN ISO 6603-2 was carried out on sheets 6×6 cm cut from the single-layer blow-moulded samples. It was determined the multi-axial impact behaviour of the materials by means of instrumented puncture test. The test specimen is penetrated normal to the plane by striker at a nominally uniform velocity. The resulting force-deformation or force time diagram is electronically recorded. The value of the total penetration energy can be calculated from the force deformation diagram and is an indication for the material toughness (Table 3).

TABLE 2
Barrier properties (D1 Container)

| | Container | | Tensile | Yield | Ultimate |
|---|---|---|---|---|---|
| | Weight | E-Modulus | stress | strain, | strain |
| Sample | [g] | [MPa] | [MPa] | [%} | [%] |
| Standard | 530 | 765 | 22.8 | 10 | >220 |
| (Rigidex | | | | | |
| HM503XP) | | | | | |
| Example 2 | 450 | 1227 | 41 | 5.4 | >450 |
| (Coloured) | | (60.4%) | (79.8%) | | |
| Blow- | 493 | 1191 | 39 | 5.3 | >450 |
| moulded | | (55.7%) | (71.0%) | | |
| containers | 527 | 1222 | 39 | 5.4 | >450 |
| | | (59.7%) | (71.0%) | | |

This indicates that the E-modulus improves by an average of 58.6% and the tensile stress improves by an average of 73.9%, in the single layer blow-moulded containers of the present invention as compared to standard HDPE containers.

TABLE 3
Puncture impact (D1 Container)

| | Total penetration energy, | Thickness, |
|---|---|---|
| Sample | [J] | [mm] |
| Reference HDPE Falling | 14 (striker penetrate | 1.7 |
| mass 4500 g | through the sample) | |
| (Example 2 | 16 (no penetration) | 1.36 |
| Coloured blow- | 15.7 (no penetration) | 1.54 |
| moulded container) | 25 (no penetration) | 1.90 |
| falling mass 5000 g | | |

The results of this test are expressed using the penetration of the sample and the force applied to penetrate it. With these D1 containers even when the energy was increased to 25J, no penetration occurred. The reference sample was destroyed at total penetration energy of 14J. This indicates a very significant improvement in the strength of the D1 containers, as compared to standard HDPE containers.

### EXAMPLE 3

### Thermo-Mechanical Properties (D1 Container)

Heat Deflection Temperature Test (HDT Test)

According to the ASTM D648 Standard the minimal sample thickness for this test should be 2.4 mm and the temperature at which the test bar deflects 0.50 mm is obtained. Heat deflection temperature (HDT) was measured on samples cut from the blow moulded containers. Due to the container wall thickness available, the thickness of some samples is less than 2.4 mm, but all samples are extrapolated for the minimum thickness of 2.4 mm. The samples thickness was 1.95 mm for the reference sample and 2.4 mm for the nanocomposite container.

The HDT results are presented in Table 4. for calculated 2.4 mm thickness

TABLE 4
Heat deflection temperature Test. (D1 Container)

| | HDT @ 1.82 |
|---|---|
| Sample | MPa [° C.] |
| Standard (Rigidex 5030XP HDPE) | 36 |
| Example 3, D1 blue (coloured blow-moulded container) | 42 |

It can be concluded that the containers produced from the D1 masterbatch material show improved mechanical thermo-mechanical and barrier properties, without a loss in the impact strength.

Tests on Nanocomposite Resin From D2

### EXAMPLE 4

### D2 Compound

Compound containing 40% by weight of organically modified clay and 60% maleated HDPE with melt index 2 ccm/10 min at load 2.16 kg (190° C.) was melt compounded in a twin screw extruder ZSK25 at processing temperatures T1 to T10: 150; 160; 170; 170; 170; 180; 180; 190; 190; 190° C. 22% of this was subsequently compounded with 88% of HDPE Matrix resin Rigidex 5030XP. The resultant melt volume index was measured as 3.7 ccm/10 min at 190° C./21.6 kg. The viscosity ratio was η_{MB}/η_{PE}=0.78 at a temperature of 190° C. and a shear rate of 100 1/s.

### EXAMPLE 5

### D2 Container

A blow-moulded container was produced using compound D2 made in Example 4, The processing conditions In extrusion blow moulding are defined as follows:

Extruder Temperatures: 170, 180, 180, 185, 190° C.

Melt temperature: 190° C.

Permeability Test

According to FIG. 4, there is illustrated the results of a permeability test which was carried out on sheets from a single-layer blow-moulded container. The sheets were cut into circular sheets having a diameter of 8 mm and were used as a seal between a small bottle and a pinhole lid. The diameter of the pinhole was 5.35 mm. The weight loss of the toluene at 21° C. in the bottles was measured periodically.

The D2 container showed a 3.5 fold improvement of the toluene permeability at 21° C. and 2.8 fold at 40° C. according to the average permeation rate per day.

A 6.7 fold improvement of the toluene permeability at 21° C. was determined for the HDPE-NC compared with the neat HDPE, considering the lowest permeation rate (FIG. 4(a)). FIG. 4b represents the lowest permeation rate measured after 4 days at 20° C., and then after another four days at 40° C. Therefore the barrier properties of D2 Containers are much improved.

Tensile Test

Samples in form of test bars are stamped from the blow-moulded container. The tensile properties Young-modulus, tensile strength, yield strain, and elongation at break of the samples are determined according DIN EN ISO 527. The results are given in Table 5.

TABLE 5
Barrier Properties (D2 Container)

| | Container | | Tensile | Yield | Ultimate |
|---|---|---|---|---|---|
| | Weight | E-Modulus | stress | strain, | strain |
| Sample | [g] | [MPa] | [MPa] | [%] | [%] |
| Reference | 530 | 765 | 22.8 | 10 | >220 |
| Rigidex | | | | | |
| HM5030XP | | | | | |
| Example 4 | 468 | 1462 | 39 | 5.0 | >500 |
| D2 | 474 | (91.1%) | (71.0%) | 4.9 | >500 |
| | 488 | 1490 | 40 | 4.7 | >500 |
| | | (94.8%) | (75.4%) | | |
| | | 1441 | 42 | | |
| | | (88.4%) | (84.2%) | | |

This indicates that the E-modulus of the D2 containers improves by an average of 91.4% and the tensile stress improves by an average of 76.8%, compared to the standard container.

Impact Test

Puncture impact test according DIN EN ISO 6603-2 was carried out on sheets 6×6 cm cut from the blow-moulded samples. The multi-axial impact behaviour of the materials by means of instrumented puncture test was determined. The test specimen is penetrated normal to the plane by striker at a nominally uniform velocity. The resulting force-deformation or force time diagram is electronically recorded. The value of the total penetration energy can be calculated from the force-deformation diagram and is an indication of the material toughness (Table 6).

TABLE 6
Puncture impact (D2 Container)

| | Total penetration energy, | Thickness, |
|---|---|---|
| Sample | [J] | [mm] |
| Reference HDPE Falling | 14 (striker penetrate | 1.7 |
| mass 4500 g | through the sample) | |
| Example 4 | 19.5 (no penetration) | 1.65 |
| D2 falling mass 5000 g | 20.2 (no penetration) | 1.82 |

The results of this test are expressed using the penetration of the sample and the force applied to penetrate it. With these D2 containers even when the energy was Increased to over 20J, no penetration occurred The reference sample was destroyed at 14J of force. This indicates a very significant improvement in the strength of the D2 containers, as compared to standard HDPE containers.

Container Drop Test

An in-house Pass/Fail container drop test is described as follows: the container is filled with 10 L at ambient temperature and a closure fitted and dropped from a height of 2 metres on to a steel surface. Both reference BP Rigidex 5030XP and D2 containers withstood the “test pass” requirement level of 3 drops. Then the test was continued to 40 drops, and both sets of containers withstood 40 drops, after which the test was discontinued.

The above in house test was also carried out at −18° C. thus indicating retention of toughness at sub-ambient temperatures. The containers were filled with water after being brought down to −18° C. overnight. Each container was dropped alternately on its base, side and top of container from height of 5 feet

Again all containers survived repeated drops, D1, D2 and the reference Rigidex surviving 15 drops before the test was discontinued.

Therefore D2 containers showed no loss in retention of impact strength at −18° C.

### EXAMPLE 6

### Thermo-Mechanical Properties

Heat Deflection Temperature Test (HDT Test)

According to ASTM D648 the minimal sample thickness should be 2.4 mm and the temperature at which the test bar deflects 0.50 mm is obtained. Heat deflection temperature (HDT) was measured on samples cut from the blow moulded containers. Due to the container wall thickness available, the thickness of some samples is less than 2.4 mm, but all samples are extrapolated for the minimum thickness of 2.4 mm. The samples thickness was 1.95 mm for the reference sample and 2.4 mm for the nanocomposite container.

The HDT results am presented in Table 7 for calculated 2.4 mm thickness.

TABLE 7
Heat deflection temperature test (D2 Container)

| Sample | HDT @ 1.82 MPa [° C.] |
|---|---|
| Rigidex 5030XP HDPE | 36 |
| Example 4, D2 | 41.5 |

### EXAMPLE 7

### Environmental Stress-Cracking Resistance (ESCR) Test (D1 and D2 Containers)

ESCR Test was carded out according to ASTM D 1693. Sample bars with dimensions 40×13 mm were cut from the container side walls (Container D1, D2, and Reference). The bars are notched unilaterally with notch length of 19 mm and 0.3-0.45 mm depth. The notched bars (10 bars from each sample) are bent at 180° and placed in specimen holder—U-shaped channels and then placed in glass tubes. The glass tubes are filled with 10% solution of nonyl-phenoxy polyethylene oxide (igepal CO630 supplied by Aldrich);

The glass tubes are placed in a thermostatic water bath at temperature of 50° C. The samples are observed according to the norm at certain inspection times (after 0.1, 025, 0.5, 1.0, 1.5, 2.0, 3, 4, 5, 8, 16, 24, 48 hours, and then every 24 hours). No cracks appeared on any of the three samples after 1000 hours. However, on visual observation, the reference samples were considerably swollen while the samples from the containers of the invention D1 and D2, did not exhibit any visible dimensional changes.

It can be concluded that the D2 containers produced from the HDPE-NC material show improved mechanical thermo-mechanical and barrier properties, without a loss in the impact strength or stress-crack resistance.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described, but may be varied in both construction and detail.

1-13. (canceled)

14. A process for producing a single-layer blow-moulded container comprising:
providing a masterbatch consisting of maleated polyethylene and a modified nanoclay in the amount of 20% to 50% by weight of the masterbatch;
directly extruding the masterbatch in the amount of 5% to 20% by weight with a polyethylene matrix resin at a viscosity ratio of between 0.3 to 1.9 at a shear rate of between 10 to 100 1/s; and
at a temperature of between 150° C. and 230° C. to form the single-layer blow-moulded container.

15. A process for producing a single-layer blow-moulded container as claimed in claim 14 wherein the viscosity of the masterbatch (η_{MB}) and the viscosity of the polyethylene matrix resin (η_{PE}) are in the ratio of between 0.7 to 1.3 at a shear rate of between 10 to 100 1/s.

16. A process for producing a single-layer blow-moulded container as claimed in claim 14 wherein the maleated polyethylene is prepared by adding maleic anhydride to polyethylene in the amount of less than 2% by weight of the polyethylene.

17. A process for producing a single-layer blow-moulded container as claimed in claim 14 wherein the nanoclay is modified by cation exchange with an alkyl ammonium ion.

18. A process for producing a single-layer blow-moulded container as claimed in claim 14 wherein the nanoclay is a natural or synthetic silicate clay.

19. A process for producing a single-layer blow-moulded container as claimed in claim 14 wherein the nanoclay is a smectite clay selected from the group consisting of one or more of montmorillonite, saponite, beidellite, nontronite and hectorite or any analogue thereof.

20. A process for producing a single-layer blow-moulded container as claimed in claim 14 wherein the concentration of nanoclay in the blow-moulded container is in the range 1% to 10% by weight of the container.

21. A process for producing a single-layer blow-moulded container as claimed in claim 14 wherein the polyethylene matrix resin is selected from the group consisting of one or more of polyethylene (PE), high density polyethylene (HDPE) and high molecular weight high density polyethylene (HMW HDPE).

22. A process for producing a single-layer blow-moulded container as claimed in claim 21 wherein the polyethylene matrix resin is HMW HDPE with a melt index in the range of between 2 g/10 min and 25 g/10 min at 21.6 kg and 190° C.

23. A process for producing a single-layer blow-moulded container as claimed in claim 14 wherein subsequent to providing the masterbatch carrying out the additional steps of:
forming a nanocomposite resin by compounding the masterbatch in the amount of 8% to 16% by weight of the nanocomposite resin with polyethylene matrix resin;
extruding the nanocomposite resin at a temperature of between 150° C. and 230° C. to form the single layer blow-moulded container.

24. A process for producing a single-layer blow-moulded container as claimed in claim 23 wherein the viscosity of the masterbatch (η_{MB}) and the viscosity of the polyethylene matrix resin (η_{PE}) are in the ratio of between 0.7 to 1.3 at a shear rate of between 10 to 100 1/s.

25. A process for producing a single-layer blow-moulded container as claimed in claim 23 wherein the maleated polyethylene is prepared by adding maleic anhydride to polyethylene in the amount of less than 2% by weight of the polyethylene.

26. A process for producing a single-layer blow-moulded container as claimed in claim 23 wherein the nanoclay is modified by cation exchange with an alkyl ammonium ion.

27. A process for producing a single-layer blow-moulded container as claimed in claim 23 wherein the nanoclay is a natural or synthetic silicate clay.

28. A process for producing a single-layer blow-moulded container as claimed in claim 23 wherein the nanoclay is a smectite clay selected from the group consisting of one or more of montmorillonite, saponite, beidellite, nontronite and hectorite or any analogue thereof.

29. A process for producing a single-layer blow-moulded container as claimed in claim 23 wherein the concentration of nanoclay in the blow-moulded container is in the range 1% to 10% by weight of the container.

30. A process for producing a single-layer blow-moulded container as claimed in claim 23 wherein the polyethylene matrix resin is selected from the group consisting of one or more of polyethylene (PE), high density polyethylene (HDPE) and high molecular weight high density polyethylene (HMW HDPE).

31. A process for producing a single-layer blow-moulded container as claimed in claim 30 wherein the polyethylene matrix resin is HMW HDPE with a melt index in the range of between 2 g/10 min and 25 g/10 min at 21.6 kg and 190° C.

32. A single-layer blow-moulded container produced by the process as claimed in claim 14.

33. A single-layer blow-moulded container produced by the process as claimed in claim 23.

34. A single-layer blow-moulded container as claimed in claim 32 having a capacity in the region of 10 L to 1000 L.

35. A single-layer blow-moulded container as claimed in claim 33 having a capacity in the region of 10 L to 1000 L.
